(19) United States
(12) Patent Application Publication
(10) Pub. No.: US 2010/0077080 A1
(43) Pub. Date: Mar. 25, 2010

(54) COMMUNICATION TERMINAL, SERVICE KIOSK, AND SERVICE PROVIDING SYSTEM AND METHOD

(76) Inventors: Tai-yeon KU, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/436,922

(22) Filed: May 7, 2009

(30) Foreign Application Priority Data
Sep. 23, 2008 (KR) 10-2008-0093052

(51) Int. Cl. G06F 15/173; G06F 17/00

(52) U.S. Cl. 709/226; 235/375

(57) ABSTRACT

A service providing method includes: transmitting service kiosk information from a service kiosk to a communication terminal at a prescribed time interval; and if a communication terminal requests a service newspaper through the transmitted service kiosk information, creating the service newspaper in accordance with terminal information of the communication terminal and transmitting the service newspaper to the communication terminal. Further, the service providing method includes, if the communication terminal requests a service through the service newspaper, dividing and buffering the requested service page by page in accordance with physical feature information from the terminal information and transmitting the requested service to the communication terminal.

### CROSS-REFERENCE TO RELATED APPLICATIONS

The present invention claims priority of Korean Patent Application No. 10-2008-0093052, filed on Sep. 23, 2008, which is incorporated herein by reference.

### FIELD OF THE INVENTION

The present invention relates to a service providing method, and in particular, to a communication terminal, a service kiosk and a service providing system and method, which are suitable for providing a personalized service corresponding to a communication terminal by using a communication terminal and a service kiosk.

### BACKGROUND OF THE INVENTION

As well known in the art, a kiosk is an apparatus or system which is located at a general place for example, a public place and through which, when a user or a client accesses, a service provider provides a service to the user or the client. Usually, such a service is repetitive, simple, and for a specific operation, and may include an information providing operation, a simple commercial transaction (for example, ticket purchase, receipt of payment, direction system), and the like.

The kiosk may provide the user with convenience and reliability. The service providing method using the kiosk ensures reduction of costs for management and an increase in productivity.

Examples of the kiosk include a kiosk connected to a network, such as an ATM machine, an automatic flight ticket vending machine, or the like, and an independent kiosk, such as an information providing apparatus in a shopping mall, or the like.

In particular, a kiosk linked to Internet includes a browser and displays HTML documents on a screen thereof. In this case, the screen is controlled by a selected hyperlink, and is suitable for information access. Therefore, the user or the client can search information about a service to be selected and can perform personal communication, such as E-mail, on the screen.

With the development of wireless Internet, a communication terminal, such as a PDA, a mobile phone, or the like, is being widely used for personal purposes, for example, watching TV or movies, photographing, E-mail access, document creation, and the like, and for enterprise purposes as a new business tool. Although a person may have several terminals, an existing portable terminal has a small memory and a small processor due to the limit of a physical size thereof, and relatively has a limited number of resources and low performance, as compared with a server.

A service providing system including such a communication terminal and a kiosk has two important problems. First, there is a problem in that although the users always want to use a service of good quality, they have different preferences. Various communication terminals are used in accordance with the users' preferences for the screen, performance, such as the CPU or the memory, or both of them. Accordingly, it is necessary to develop a service to support all the communication terminals. Although there is a standardized service, such as a Web service or the like, it is just the service standard, and all the communication terminals do not provide such a service. As a result, when the user wants to use a terminal according to his/her preference, if the terminals provide a limited number of services, the user has fewer choices.

Second, there is a problem in that a service is provided through the Web or a service provider only in a limited environment, such as wireless environment. The user wants to use different services according to where the user is or what the user does, for example, when the user is in the park or at school or work. If a service is provided with no regard for such situations, there is a limit to meet the user's wants.

### SUMMARY OF THE INVENTION

In view of the above, the present invention provides a communication terminal, a service kiosk, and a service providing system and method, which are capable of providing a communication terminal with a personalized service anytime and anywhere by using a service kiosk.

Further, the present invention provides a communication terminal, a service kiosk, and a service providing system and method, which are capable of providing a communication terminal with a personalized service by dividing a requested service into a plurality of executable pages in accordance with terminal information of the communication terminal and transmitting the divided pages.

In accordance with a first aspect of the present invention, there is provided a service providing method including: transmitting service kiosk information from a service kiosk to a communication terminal at a prescribed time interval; if a communication terminal requests a service newspaper through the transmitted service kiosk information, creating the service newspaper in accordance with terminal information of the communication terminal and transmitting the service newspaper to the communication terminal; and if the communication terminal requests a service through the service newspaper, dividing and buffering the requested service page by page in accordance with physical feature information from the terminal information and transmitting the requested service to the communication terminal.

In accordance with a second aspect of the present invention, there is provided a service kiosk including: a service assembler for creating a service newspaper in accordance with terminal information of a communication terminal and creating a plurality of services in accordance with the terminal information; a service registry/repository for storing, managing and providing the services, together with service information; and a kiosk processor for receiving a service newspaper request from the communication terminal, transmitting the service newspaper, extracting and analyzing a service requested by the communication terminal from among the services, dividing and buffering the requested service page by page in accordance with physical feature information from the terminal information, and sequentially transmitting the requested service to the communication terminal.

In accordance with a third aspect of the present invention, there is provided a communication terminal including: a communication module for performing wireless communication; and a state manager for receiving and searching service kiosk information through the communication module, transmitting terminal information to a service kiosk, providing a service newspaper to be received in accordance with the terminal information and receiving and executing a service from the service kiosk in a page unit.

In accordance with a fourth aspect of the present invention, there is provided a service proving system including: a communication terminal for mounting a state manager thereon to receive and search service kiosk information, transmitting terminal information according to a service newspaper request, providing the service newspaper to be received, and sequentially receiving and executing a service requested through the service newspaper page by page; and a service kiosk for creating the service newspaper according to the terminal information, transmitting the created service newspaper to the communication terminal, analyzing the requested service, dividing and buffering the requested service in accordance with physical feature information from the terminal information in a page unit, and transmitting the requested service to the communication terminal in a page unit.

In accordance with the aspects of the present invention, a communication terminal having a limited number of resources can use a large service, and various services can be provided anytime and anywhere, regardless of the limits of a small communication terminal. A service, for example, a navigation service or the like, which requires a large capacity of memory, can be provided to and executed on a small communication terminal. In addition, a service can be provided with only necessary portions, and thus wireless packets can be prevented from being wastefully transmitted. As a result, accounting of wireless packets can be reduced, and the user can be satisfied with the service.

### BRIEF DESCRIPTION OF THE DRAWINGS

The objects and features of the present invention will become apparent from the following description of an embodiment given in conjunction with the accompanying drawings, in which:

FIG. 1 is a block diagram showing a service providing system for providing a communication terminal with a personalized service based on a request from the communication terminal through a service kiosk in accordance with an embodiment of the present invention;

FIG. 2 is a detailed block diagram of a service kiosk in accordance with an embodiment of the present invention;

FIG. 3 is a detailed block diagram of a kiosk processor in accordance with an embodiment of the present invention;

FIGS. 4A to 4C are diagrams illustrating a buffering mechanism of a state manager of a communication terminal and a service kiosk in accordance with an embodiment of the present invention;

FIG. 5 is a diagram showing types of services to be created in accordance with an embodiment of the present invention;

FIG. 6 is a diagram showing a service assembly to be executed in accordance with an embodiment of the present invention;

FIG. 7 is a diagram showing an example of service division in accordance with an embodiment of the present invention;

FIG. 8 is a flowchart showing a procedure for providing a personalized service through a communication terminal and a service kiosk in accordance with an embodiment of the present invention; and

FIG. 9 is a flowchart showing a procedure for serving roaming while a personalized service is being provided in accordance with an embodiment of the present invention.

### DETAILED DESCRIPTION OF THE EMBODIMENT

Hereinafter, an embodiment of the present invention will be described in detail with reference to the accompanying drawings which form a part hereof.

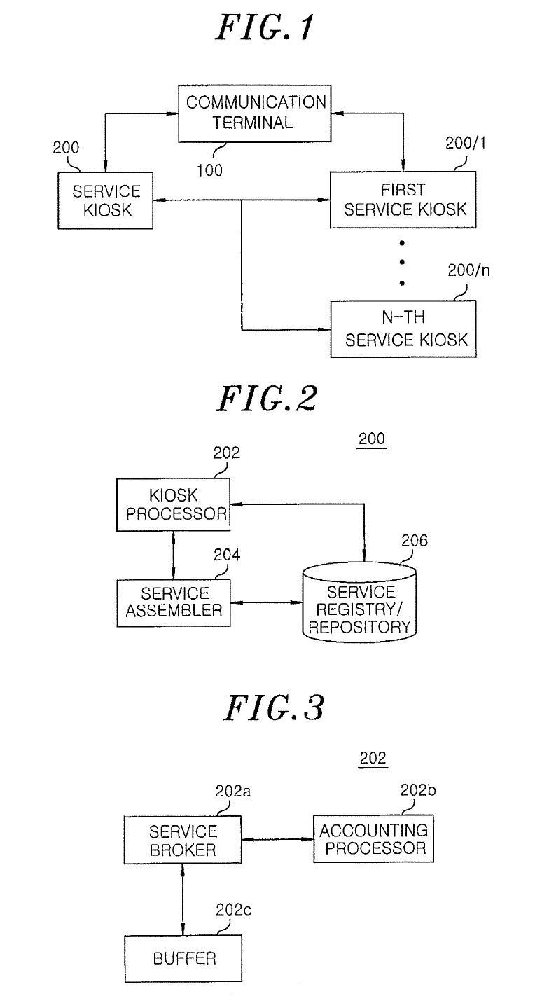

FIG. 1 is a block diagram of a service providing system for providing a communication terminal with a personalized service based on a request from the communication terminal through a service kiosk in accordance with an embodiment of the present invention. The service providing system includes a communication terminal 100, a service kiosk 200, and first to n-th service kiosks 200/1 to 200/n.

Referring to FIG. 1, the communication terminal 100 includes, e.g., a PDA, a mobile communication terminal or the like. The communication terminal 100 has a function to execute and manage various services. The communication terminal 100 is provided with a state manager (not shown) that has a function to discover a service kiosk 200, which can provide a service corresponding to the terminal, and a communication module (not shown) that performs near field communication, wireless communication, mobile communication, or the like with other devices. The state manager has user preference information regarding favorites on the communication terminal 100, physical feature information regarding a memory, a CPU, a display, an input device and the like, and software feature information regarding OS, graphic library, service framework, service viewer and the like.

The communication terminal 100 searches the service kiosk 200 at a prescribed time interval through the communication module in order to subscribe to a service newspaper including a service corresponding to the terminal by using the state manager and the service kiosk discovery protocol. The communication terminal 100 continuously searches a prescribed port to correspond to the service kiosk 200. The communication terminal 100 receives the advertisements of the service kiosk 200, i.e., service kiosk information through such a port and the communication module. If a user requests a service newspaper, the communication terminal 100 transmits terminal information to the service kiosk 200 through the communication module.

The communication terminal 100 receives a service corresponding to the terminal information from the service kiosk 200 in a page unit through the communication module by using the state manager, executes the service in an action unit, and transmits information regarding a page being executed to the service kiosk 200 through the communication module. The service that is received in a page unit can be provided to the communication terminal 100 through the state manager in the same manner as the service mounted on the communication terminal 100.

The communication terminal 100 provides the service newspaper received from the service kiosk 200 through a newspaper viewer by using the state manager. A service newspaper that is provided through such a newspaper viewer includes an input function to request to execute a service.

The service kiosk 200 provides a service to the communication terminal 100. The service kiosk 200 creates (publishes) a user-personalized service newspaper in accordance with the terminal information of the communication terminal 100, transmits the service newspaper to the communication terminal 100. If a service request is received from the communication terminal 100, the service kiosk 200 buffers the requested service with a predetermined size in accordance with the physical feature information from the terminal information and then transmits the requested service. In this case, the service newspaper may include service accounting information. The first to n-th service kiosks 200/1 to 200/n are connected to the service kiosk 200 through a network and can provide the same service. Of course, the first to n-th service kiosks 200/1 to 200/n may provide different services.

FIG. 2 is a detailed block diagram of the service kiosk in accordance with the embodiment of the present invention. The service kiosk 200 includes a kiosk processor 202, a service assembler 204 and a service registry/repository 206.

The kiosk processor 202 notifies presence of the service kiosk 200 to the communication terminal 100 and the first and n-th service kiosks 200/1 to 200/n at a prescribed time interval. The kiosk processor 202 grasps an available service in connection with the service assembler 204, receives a service newspaper including a service list from the service assembler 204 and transmits the service newspaper to the communication terminal 100. If the terminal information is transmitted from the communication terminal 100, the kiosk processor 202 transmits the terminal information to the service assembler 204. The kiosk processor 202 transmits a user-personalized service newspaper corresponding to the terminal information from the service assembler 204 to the communication terminal 100.

The kiosk processor 202 analyzes a service requested by the communication terminal 100 in connection with the service registry/repository 206, divides and buffers the service with a size corresponding to the physical feature information from the terminal information, and sequentially transmits the buffered service to the communication terminal 100. The service newspaper may include service accounting information, and the service accounting information may be internally stored and managed in accordance with the terminal information of the communication terminal 100 and specifications of services.

The kiosk processor 202 has a service roaming function with respect to the first to n-th service kiosks 200/1 to 200/n. With this function, when the communication terminal 100 is out of the range, i.e., service area of the service kiosk 200, the kiosk processor 202 searches a service kiosk, which can provide a service to the communication terminal 100, from among the first to n-th service kiosks 200/1 to 200/n), and performs service roaming to one of the first to n-th service kiosks 200/1 to 200/n.

FIG. 3 is a detailed block diagram of the kiosk processor in accordance with the embodiment of the present invention. The kiosk processor 202 includes a service broker 202a, an accounting processor 202b, and a buffer 202c.

The service broker 202a notifies presence of the service kiosk 200 to the communication terminal 100 and the first to n-th service kiosks 200/1 to 200/n at a prescribed time interval. The service broker 202a grasps an available service in connection with the service assembler 204, transmits a service newspaper from the service assembler 204 to the communication terminal 100. If the terminal information is transmitted from the communication terminal 100, the service broker 202a transmits the user-personalized service newspaper from the service assembler 204 to the communication terminal 100. The service broker 202a analyzes the service requested by the communication terminal 100 in connection with the service registry/repository 206, divides and buffers the service with a size corresponding to the terminal information, i.e., the physical feature information), and sequentially transmits the buffered service to the communication terminal 100. When the communication terminal 100 is out of the range (service area) of the service kiosk 200, the service broker 202 performs communication with the service brokers of the first to n-th service kiosks 200/1 to 200/n, searches a service kiosk, which can provide a service to the communication terminal 100, from among them, and performs service roaming to one of the first to n-th service kiosks 200/1 to 200/n.

When a service newspaper is created through the service broker 202a, the accounting processor 202b calculates and processes accounting information regarding services to be provided through the service newspaper, and stores and manages the service accounting information.

When the service broker 202a provides the requested service, the buffer 202c divides and temporarily stores the requested service with a size corresponding to the terminal information, and sequentially transmits the buffered service to the service broker 202a for transmission to the communication terminal 100.

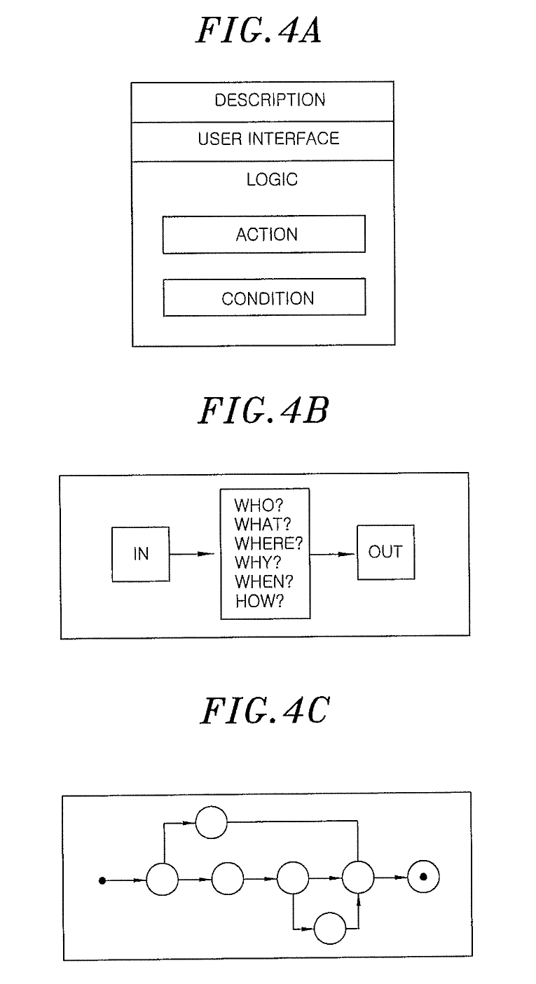

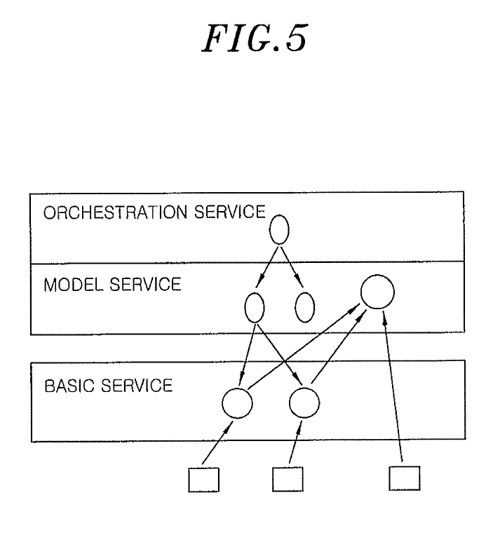

FIGS. 4A to 4C are diagrams illustrating a buffering mechanism of the state manager of the communication terminal and the service kiosk in accordance with the embodiment of the present invention. As shown in FIG. 4A, the constituent elements of the service broadly include Description, User Interface, and Logic. In Description, information regarding specifications of services and an interface are described. User Interface is an interface that can perform paging. Logic relates to actual driving. With respect to the logic, as shown in FIG. 4C, a single small action branches off other actions according to conditions. Description may be service specifications based on 5W1H in an input/output message definition structure shown FIG. 4B.

When the communication terminal 100 executes the service, if a memory is insufficient to execute the service, the service broker 202a divides the service of large size into actions in accordance the physical feature information, such as memory size, of the communication terminal 100, and gives a page number to each action. In the buffer 202c, a buffering order of the actions may be defined based on the page number. The buffering order should be changed depending on the current service execution state. Therefore, it is necessary for real-time information exchange between the state manager of the communication terminal 100 and the service broker 202a.

The service assembler 204 grasps availability of a service registered in the service registry/repository 206, and provides information regarding available services to the service broker 202a. The service assembler 204 analyzes the specification of the basic service stored in the service registry/repository 206, creates a new model service, and creates an orchestration service by a combination of model services or a single model service in accordance with a request from the service broker 202a. The model service may be created by a combination of basic services based on 5W1H of a predefined model. The model service may be created by creating the specifications of the basic services. The orchestration service may be created by a combination of service models.

The service assembler 204 checks whether or a plurality of services created according to a request from the service broker 202a match with the terminal information. A service list that includes services to be executable on the communication terminal 100 is created as a service newspaper and provided to the service broker 202a.

FIG. 5 is a diagram showing types of services to be created in accordance with the embodiment of the present invention. Services are classified into services having a single function to be actually developed by a developer and high-order services using (combining) services having a single function. In this embodiment, the services are classified into basic services, model services, and orchestration services. Each of the basic services actually executes a single function, and means a service that is created and stored by the developer. The model services are created by combinations of basic services for specific purposes. A single basic service may be a single model service. The model services mean services that are created by combinations of services to be frequently requested or basic services of respective service kiosk based on a prescribed model.

The service broker 202a cyclically transmits the service newspaper on the basis of the terminal information of the communication terminal 100 and the user's preference. This service newspaper is created by a combination of model services and means the orchestration service.

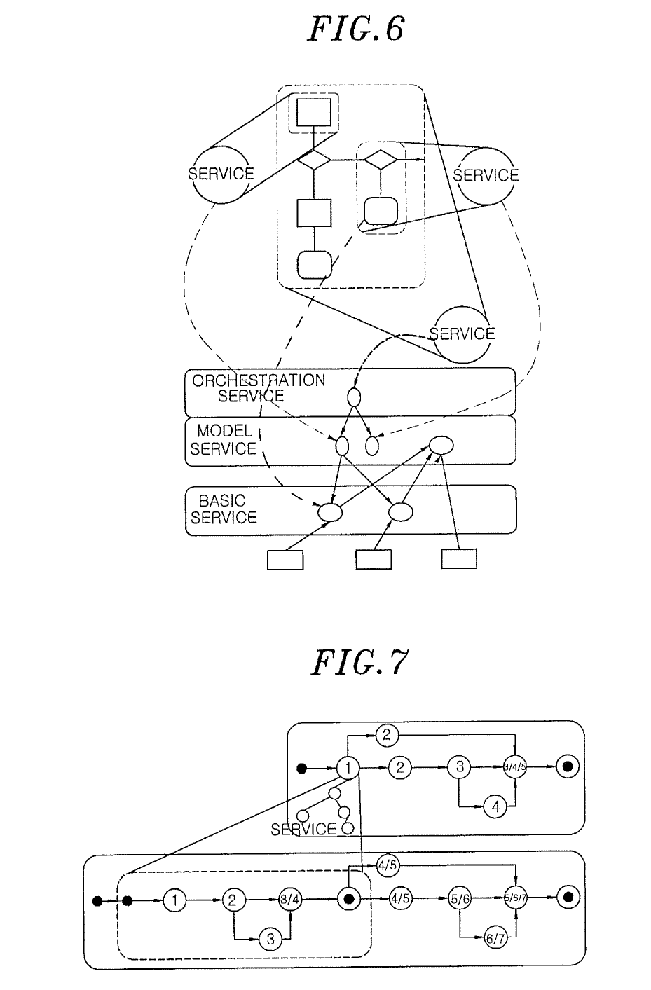

FIG. 6 is a diagram showing a service assembly to be executed in accordance with the embodiment of the present invention. When a service is transmitted by a combination of services (for example, basic services, model services, orchestration services, and the like), the service is divided into pages in accordance with the memory size of the communication terminal 100. When a service is requested, the buffering unit is checked on the basis of the orchestration service. A single orchestration service is formed based on multiple model services. As shown in FIG. 4C, the action branches off other actions according to a predetermined condition. In this case, the action is made based on the model service. Each service may be divided into services according to determination and processing of flows in the dashed-line regions, as shown in FIG. 6.

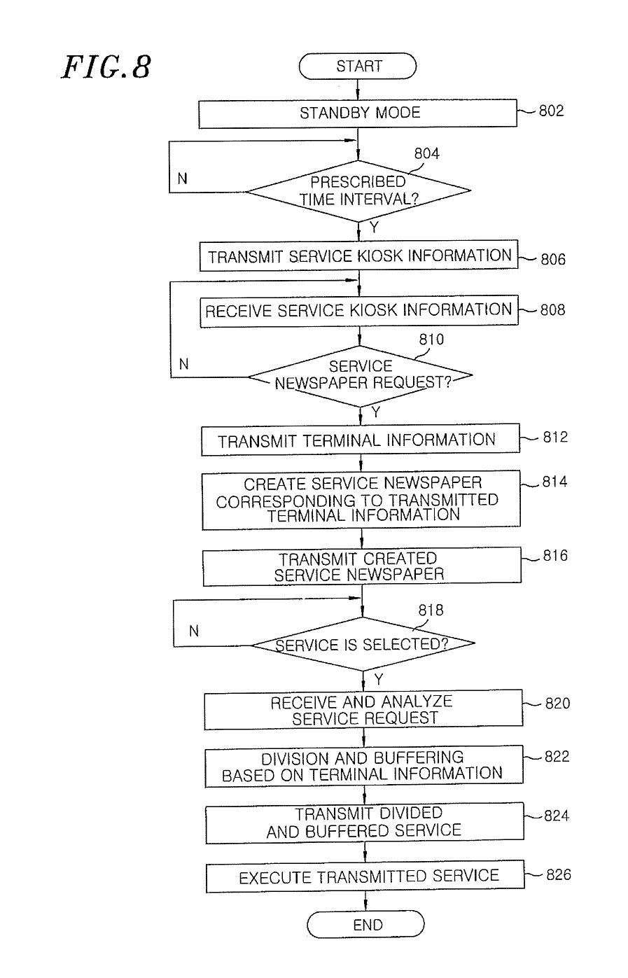

FIG. 7 is a diagram showing an example of service division in accordance with an embodiment of the present invention. During service analysis, the service broker 202a divides the service into actions based on the model service, and analyzes whether or not there is an action that requires a memory capacity larger than that of the communication terminal 100 with respect to each of the divided actions. When a large memory capacity is needed, the action, i.e., the model service is divided into a combination of basic services, as shown in FIG. 7, and then the pages are rearranged. In FIG. 7, an upper side shows the analysis result of the orchestration service as a model service of a single action. Here, it can be seen that the first page exceeds the memory size of the communication terminal 100, and then it is divided into pages based on the basic services.

Each page is given a number again in such a manner that, when a page is provided next to the current page according to the condition, the number is incremented by 1. An action may be given multiple page numbers. In this case, the pages to be buffered again are transmitted with marks. Accordingly, the number of times of retransmission can be reduced.

Referring back to the FIG. 2, the service registry/repository 206 stores and manages services to be provided by the service kiosk 200. In the service registry/repository 206, services (basic services) created by the developer and services (model service and orchestration services) created by the service assembler 204 are all registered and stored. Information and logic concerning the services are stored in the repository, and storage information is stored in the registry.

Next, in the service providing system having the above-described configuration, in a state where the service kiosk information is transmitted to the communication terminal at a prescribed time interval, when a service list is requested, the terminal information is transmitted, and the service newspaper corresponding to the terminal information is created and transmitted. If a service is selected through the service newspaper, the selected service is divided and buffered with a size corresponding to the terminal information. Then, the buffered service is sequentially transmitted to the communication terminal. This procedure will now be described.

FIG. 8 is a flowchart showing a procedure for providing a personalized service through the communication terminal and the service kiosk in accordance with the embodiment of the present invention.

In a standby mode of the service providing system (Step 802), the service kiosk 200 checks the prescribed time interval to transmit the service kiosk information (Step 804).

In Step 804, if the prescribed time interval is checked, the service broker 202a of the kiosk processor 202 in the service kiosk 200 transmits the service kiosk information including information regarding presence/absence of the service kiosk 200 to the communication terminal 100 and the first to n-th service kiosks 200/1 to 200/n within the service area (Step 806). The service kiosk information may be transmitted to the communication terminal 100 and the first to n-th service kiosks 200/1 to 200/n in the form of advertisements.

The communication terminal 100 receives the service kiosk information that is transmitted at the prescribed time interval (Step 808). The service kiosk information in the form of advertisements may be displayed through a predetermined program viewer (for example, a service newspaper viewer or the like) of the communication terminal 100.

Next, if the user operates a selection key for service newspaper request by using an input unit (not shown), for example, a keypad or the like, the communication terminal 100 checks whether or not a corresponding request signal is input (Step 810).

In Step 810, if it is determined that the service newspaper request signal is input, the communication terminal 100 transmits the terminal information (for example, user preference information, physical feature information, software feature information, and the like) to the service kiosk 200, together with the request signal (Step 812).

The service kiosk 200 creates a service newspaper including a service list regarding services to be executable on the communication terminal 100 on the basis of the terminal information by using the service broker 202a of the kiosk processor 202 and the service registry/repository 206 of the service assembler 204 (Step 814).

Next, the service broker 202a incorporates service accounting information regarding the services into the service newspaper created by the accounting processor 202b, buffers the service newspaper by using the buffer 202c in a page unit, and sequentially transmits the buffered service newspaper to the communication terminal 100 (Step 816).

The communication terminal 100 receives the service newspaper that is sequentially transmitted, and displays the service newspaper through the service newspaper viewer or the like. Next, if the user input a selection key for specific service request on the service newspaper by using the input unit (not shown), for example, a keypad or the like, the communication terminal 100 checks whether or not a corresponding request signal is input (Step 818).

In Step 818, if it is determined that a specific service request signal is input, the communication terminal 100 transmits the request signal to the service kiosk 200. The service broker 202a of the kiosk processor 202 receives the request signal and analyzes the requested service in connection with the service registry/repository 206 (Step 820).

The service broker 202a divides the requested service with a predetermined size in accordance with the analysis result, the terminal information, and the physical feature information of the communication terminal 100 regarding the memory, the CPU, the display, the input device and the like, and buffers the requested service in the buffer 202c (Step 822).

The service broker 202a sequentially transmits the divided and buffered service to the communication terminal 100 (Step 824). The communication terminal 100 receives the service to be sequentially transmitted and executes the service through the state manager (Step 826).

Therefore, in the service providing system including the communication terminal and the service kiosk, a personalized service newspaper is requested and provided by using the service kiosk information, which is transmitted at a prescribed time interval, and then the selected service can be received and effectively provided.

Next, as described above, when the communication terminal is out of the service area of the service kiosk while a personalized service is being provided to the communication terminal, service roaming to search a different service kiosk, which provides the same service in the area where the communication terminal is located, and to provide the personalized service by using the searched service kiosk will be described.

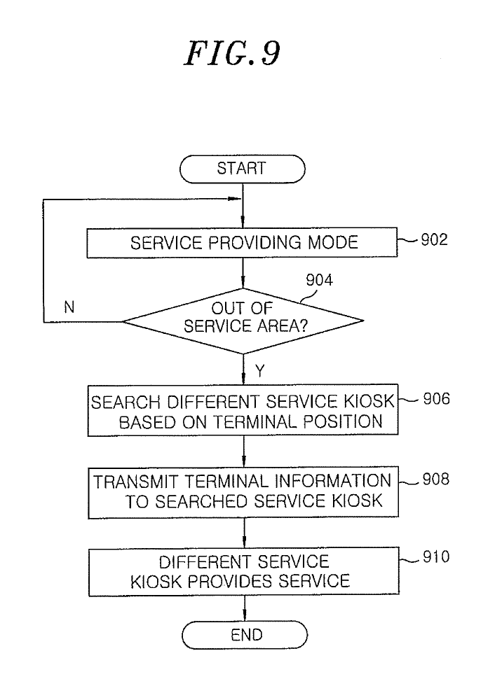

FIG. 9 is a flowchart showing service roaming while a personalized service is being provided in accordance with the embodiment of the present invention.

As described above, in the personalized service providing mode (Step 902) described with reference to FIG. 8, the service kiosk 200 checks whether or not the communication terminal 100, to which a service is being provided, is out of the service area of the service kiosk 200 (Step 904).

In Step 904, if it is determined that the communication terminal 100 is out of the service area, the service broker 202a of the kiosk processor 202 in the service kiosk 200 performs communication with the service brokers of the first to n-th service kiosks 200/1 to 200n, and checks whether or not there is a different service kiosk that can provide the same service at the position of the terminal (Step 906).

If a different service kiosk that can provide the same service at the position of the terminal is searched, the service broker 202a transmits the terminal information of the communication terminal 100 to the service broker of the searched service kiosk (Step 908).

Next, the service broker of the different service kiosk continuously provides the same service to the communication terminal 100 (Step 910).

Therefore, if the communication terminal is out of the service area of the service kiosk while the personalized service is provided using the communication terminal and the service kiosk, a different service kiosk that can provide the same service is searched, and the terminal information is transmitted to the searched service kiosk. In this way, the service can be continuously provided. As a result, service roaming can be effectively executed between a plurality of service kiosks.

While the invention has been shown and described with respect to the embodiment, it will be understood by those skilled in the art that various changes and modifications may be made without departing from the scope of the invention as defined in the following claims.

What is claimed is:

1. A service providing method comprising:
transmitting service kiosk information from a service kiosk to a communication terminal at a prescribed time interval;
if a communication terminal requests a service newspaper through the transmitted service kiosk information, creating the service newspaper in accordance with terminal information of the communication terminal and transmitting the service newspaper to the communication terminal; and
if the communication terminal requests a service through the service newspaper, dividing and buffering the requested service page by page in accordance with physical feature information from the terminal information and transmitting the requested service to the communication terminal.

2. The serving providing method of claim 1, wherein transmitting the requested service to the communication terminal includes:
when the communication terminal is out of the service area of the service kiosk while the requested service is executed, searching another service kiosk that provides the requested service;
if the different service kiosk is searched, transmitting the terminal information; and
providing the requested service from the another service kiosk to the communication terminal in accordance with the terminal information.

3. The service providing method of claim 1, wherein in transmitting the service kiosk information, the service kiosk information is transmitted through a prescribed port in the form of advertisement indicating presence of the service kiosk.

4. The service providing method of claim 1, wherein the terminal information includes user preference information regarding favorites, physical feature information regarding a memory, a CPU, a display and an input device, and software feature information regarding OS, graphic library, service framework and service viewer.

5. The service providing method of claim 1, wherein the service newspaper is created to have a service list and service accounting information.

6. The service providing method of claim 5, wherein the service newspaper is displayed through a service newspaper viewer provided in the communication terminal.

7. A service kiosk comprising:
a service assembler for creating a service newspaper in accordance with terminal information of a communication terminal and creating a plurality of services in accordance with the terminal information;
a service registry/repository for storing, managing and providing the services, together with service information; and
a kiosk processor for receiving a service newspaper request from the communication terminal, transmitting the service newspaper, extracting and analyzing a service requested by the communication terminal from among the services, dividing and buffering the requested service page by page in accordance with physical feature information from the terminal information, and sequentially transmitting the requested service to the communication terminal.

8. The service kiosk of clam 7, wherein the kiosk processor includes:
a service broker for performing transmission of the service kiosk information, reception of the service newspaper request, transmission of the service newspaper, transmission of the requested service, and service roaming to a service broker of a different service kiosk through communication;
a accounting processor for transmitting service accounting information to the service broker to be incorporated into the service newspaper, and
a buffer for buffering the requested service with a size corresponding to the physical feature information, and sequentially transmitting the requested service to the service broker.

9. The service kiosk of claim 8, wherein, when the communication terminal is out of the service area of the service kiosk while the requested service is being executed, the service broker performs service roaming to search a different service kiosk that provides the requested service and to cause the different service kiosk to provide the requested service.

10. The service kiosk of claim 9, wherein the service broker transmits the terminal information to the different service kiosk to perform service roaming.

11. The service kiosk of claim 8, wherein the terminal information includes user preference information regarding favorites, physical feature information regarding a memory, a CPU, a display and an input device, and software feature information regarding OS, graphic library, service framework and service viewer.

12. A communication terminal comprising:
a communication module for performing wireless communication; and
a state manager for receiving and searching service kiosk information through the communication module, transmitting terminal information to a service kiosk, providing a service newspaper to be received in accordance with the terminal information and receiving and executing a service from the service kiosk in a page unit.

13. The communication terminal of claim 12, wherein the state manager displays the service newspaper through a newspaper viewer.

14. The communication terminal of claim 13, wherein the terminal information includes user preference information regarding favorites, physical feature information regarding a memory, a CPU, a display and an input device, and software feature information regarding OS, graphic library, service framework and service viewer.

15. A service proving system comprising:
a communication terminal for mounting a state manager thereon to receive and search service kiosk information, transmitting terminal information according to a service newspaper request, providing the service newspaper to be received, and sequentially receiving and executing a service requested through the service newspaper page by page; and
a service kiosk for creating the service newspaper according to the terminal information, transmitting the created service newspaper to the communication terminal, analyzing the requested service, dividing and buffering the requested service in accordance with physical feature information from the terminal information in a page unit, and transmitting the requested service to the communication terminal in a page unit.

16. The service providing system of claim 15, wherein the service kiosk includes:
a service kiosk processor for performing transmission of the service kiosk information through communication with the communication terminal, reception of the terminal information and transmission of the service newspaper, transmission of the requested service, processing of service accounting information, and service roaming to a different service kiosk;
an service assembler for creating the service newspaper in accordance with the terminal information and creating a plurality of services in accordance with the terminal information; and
a service registry/repository for storing, managing, and providing the services, together with service information.

17. The service providing system of claim 16, wherein the service kiosk processor includes:
a service broker for performing transmission of the service kiosk information through communication with the communication terminal, reception of the terminal information and transmission of the service newspaper, transmission of the requested service, and service roaming to a different service kiosk when the communication terminal is out of the service area,
an accounting processor for processing the service accounting information to be incorporated into the service newspaper, and
a buffer for buffering the requested service with a size corresponding to the physical feature information, and sequentially transmitting the requested service to the service broker.

18. The service providing system of claim 17, wherein, when executing a service roaming, the service broker transmits the terminal information to the different service kiosk.

19. The service providing system of claim 18, wherein the terminal information includes user preference information regarding favorites, physical feature information regarding a memory, a CPU, a display and an input device, and software feature information regarding OS, graphic library, service framework and service viewer.

20. The service providing system of claim 17, wherein the service newspaper is formed page by page to have a service list and the service accounting information.
